(19) United States
(12) Patent Application Publication
(10) Pub. No.: US 2024/0357408 A1
(43) Pub. Date: Oct. 24, 2024

(54) FIRST WIRELESS COMMUNICATION DEVICE, SECOND WIRELESS COMMUNICATION DEVICE, WIRELESS COMMUNICATION SYSTEM, AND WIRELESS COMMUNICATION METHOD

(71) Applicant: FUJITSU LIMITED, Kawasaki-shi Kanagawa (JP)

(72) Inventors: Yoshiaki OHTA, Yokohama (JP); YOSHIHIRO KAWASAKI, Kawasaki (JP)

(73) Assignee: FUJITSU LIMITED, Kawasaki-shi (JP)

(21) Appl. No.: 18/761,401

(22) Filed: Jul. 2, 2024

Related U.S. Application Data
(63) Continuation of application No. PCT/JP2022/000423, filed on Jan. 7, 2022.

(51) Int. Cl. H04W 24/10; H04W 72/0446; H04W 72/0453

(52) U.S. Cl. CPC H04W 24/10; H04W 72/0446; H04W 72/0453

(57) ABSTRACT

A first wireless communication device included in a wireless communication system, the first wireless communication device includes, a communicator that performs communication with a second wireless communication device supporting a survival time, and a controller configured to control allocation of a radio resource for data transmission in terms of frequency band and time domain, in a survival time mode in which the survival time is being applied, and configured to control, in accordance with the survival time and information on a radio measurement duration during which the second wireless communication device performs radio measurement, configuration of the radio measurement duration.

This application is a continuation application of International Application Number PCT/JP2022/000423 filed on Jan. 7, 2022 and designated the U.S., the entire contents of which are incorporated herein by reference.

### FIELD

The present disclosure relates to a first wireless communication device, a second wireless communication device, a wireless communication system, and a wireless communication method.

### BACKGROUND

In recent years, wireless communication systems that utilize wireless communication are used. Wireless communication systems are also used in facilities such as factories, for example.

In factories, for example, manufacturing equipment and apparatuses are wirelessly connected to a control monitoring system, and data and control signals are transmitted and received by using the IoT (Internet of Things). The IoT used in factories may also be referred to specifically as the IIOT (Industrial IoT).

If missing reception or the like of a control signal occurs in a factory, a serious error may occur, such as stagnation or interruption of a production line of the factory, and therefore, the IIOT may be desired to accommodate severer delay or error conditions than the normal IoT. Thus, in the IIOT, provided that predetermined conditions are met, a communication device transitions to a state (hereinafter also referred to as “survival time mode (STM)”) in which the communication device needs to ensure that data arrives within a packet arrival time limit (hereinafter also referred to as “survival time”) acceptable to the system, to thereby improve the probability of data arrival.

IIoT-related technologies are described in the following related art documents:
Non-Patent Literature 1: 3GPP TS36.133 LTE-A Radio measurement specification;
Non-Patent Literature 2: 3GPP TS36.300 LTE-A Overview specification;
Non-Patent Literature 3: 3GPP TS36.211 LTE-A PHY channel specification;
Non-Patent Literature 4: 3GPP TS36.212 LTE-A PHY coding specification;
Non-Patent Literature 5: 3GPP TS36.213 LTE-A PHY procedure specification;
Non-Patent Literature 6: 3GPP TS36.214 LTE-A PHY measurement specification;
Non-Patent Literature 7: 3GPP TS36.321 LTE-A MAC specification;
Non-Patent Literature 8: 3GPP TS36.322 LTE-A RLC specification;
Non-Patent Literature 9: 3GPP TS36.323 LTE-A PDCP specification;
Non-Patent Literature 10: 3GPP TS36.331 LTE-A RRC specification;
Non-Patent Literature 11: 3GPP TS36.413 LTE-A S1 specification;
Non-Patent Literature 12: 3GPP TS36.423 LTE-A X2 specification;
Non-Patent Literature 13: 3GPP TS36.425 LTE-A Xn specification;
Non-Patent Literature 14: 3GPP TR36.912 NR Radio access overview;
Non-Patent Literature 15: 3GPP TR38.913 NR Requirements;
Non-Patent Literature 16: 3GPP TR38.801 NR Network architecture overview;
Non-Patent Literature 17: 3GPP TR38.802 NR PHY overview;
Non-Patent Literature 18: 3GPP TR38.803 NR RF overview;
Non-Patent Literature 19: 3GPP TR38.804 NR L2 overview;
Non-Patent Literature 20: 3GPP TR38.900 NR High frequency overview;
Non-Patent Literature 21: 3GPP TS38.300 NR Overview specification;
Non-Patent Literature 22: 3GPP TS37.340 NR Multi-connectivity overview specification;
Non-Patent Literature 23: 3GPP TS38.201 NR PHY specification overview specification;
Non-Patent Literature 24: 3GPP TS38.202 NR PHY service overview specification;
Non-Patent Literature 25: 3GPP TS38.211 NR PHY channel specification;
Non-Patent Literature 26: 3GPP TS38.212 NR PHY coding specification;
Non-Patent Literature 27: 3GPP TS38.213 NR PHY data channel procedure specification;
Non-Patent Literature 28: 3GPP TS38.214 NR PHY control channel procedure specification;
Non-Patent Literature 29: 3GPP TS38.215 NR PHY measurement specification;
Non-Patent Literature 30: 3GPP TS38.321 NR MAC specification;
Non-Patent Literature 31: 3GPP TS38.322 NR RLC specification;
Non-Patent Literature 32: 3GPP TS38.323 NR PDCP specification;
Non-Patent Literature 33: 3GPP TS37.324 NR SDAP specification;
Non-Patent Literature 34: 3GPP TS38.331 NR RRC specification;
Non-Patent Literature 35: 3GPP TS38.401 NR Architecture overview specification;
Non-Patent Literature 36: 3GPP TS38.410 NR Core network overview specification;
Non-Patent Literature 37: 3GPP TS38.413 NR Core network AP specification;
Non-Patent Literature 38: 3GPP TS38.420 NR Xn interface overview specification;
Non-Patent Literature 39: 3GPP TS38.423 NR XnAP specification;
Non-Patent Literature 40: 3GPP TS38.470 NR F1 interface overview specification;
Non-Patent Literature 41: 3GPP TS38.473 NR F1AP specification; and
Non-Patent Literature 42: 3GPP TSG RAN meeting #92e Electronic Meeting, Jun. 14-18, 2021 RP-211566.

### SUMMARY

A first wireless communication device included in a wireless communication system, the first wireless communication device includes, a communicator configured to perform communication with a second wireless communication device supporting a survival time, and a controller configured to control allocation of a radio resource for data transmission in terms of frequency band and time domain, in a survival time mode in which the survival time is being applied, and configured to control, in accordance with the survival time and information on a radio measurement duration during which the second wireless communication device performs radio measurement, configuration of the radio measurement duration.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 illustrates an example configuration of a wireless communication system 1.

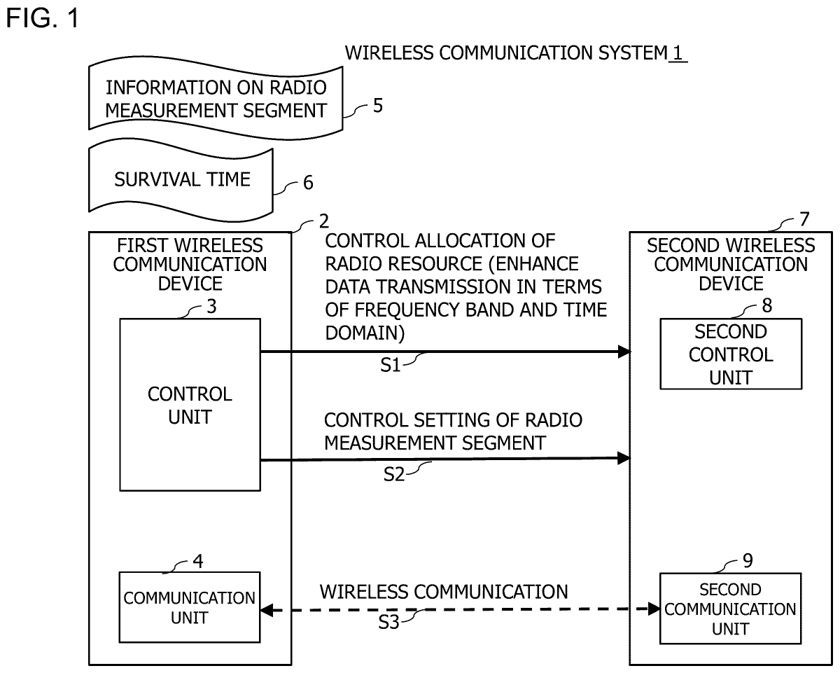

FIG. 2 illustrates an example configuration of a wireless communication system 10.

FIG. 3 illustrates an example configuration of the base station device 200.

FIG. 4 illustrates an example configuration of the terminal device 100.

FIG. 5 illustrates an example of the survival mode.

FIG. 6 illustrates an example in which radio resources are added in order to reinforce data transmission in the frequency domain.

FIG. 7 illustrates an example (pattern 1) in which radio resources are added in order to reinforce data transmission in the time domain.

FIG. 8 illustrates an example (pattern 2) in which radio resources are added in order to reinforce data transmission in the time domain.

FIG. 9 illustrates an example (pattern 3) in which radio resources are added in order to reinforce data transmission in the time domain.

FIG. 10 illustrates an example of whether or not MG is performed when the MG duration is longer than the transmission interval.

FIG. 11 illustrates an example of whether or not MG is performed when the MG duration is shorter than the transmission interval.

FIG. 12 illustrates an example in which MG is performed when the MG duration is shorter than the transmission interval.

### DESCRIPTION OF EMBODIMENTS

Measures and methods for improving the probability of data arriving within a survival time, with respect to a communication device in the survival mode, are currently under discussion and have not yet been determined.

According to one aspect of the present disclosure, during the survival time mode of the IIOT, the probability of data arrival can be improved.

### First Embodiment

A first embodiment will be described.

A wireless communication system 1 is a communication system that supports survival time. A duration (period of time) corresponding to a survival time may also be referred to as “survival time mode (duration)”. The wireless communication system 1 includes a first wireless communication device 2 and a second wireless communication device 7. The first wireless communication device 2 and the second wireless communication device 7 both support survival time and communicate wirelessly with each other.

The first wireless communication device 2 is a communication device including a control unit 3 and a communication unit 4. The control unit 3 and the communication unit 4 are composed, for example, of a processor (computer) included in the first wireless communication device 2 executing a program loaded into a memory.

The control unit 3 can control allocation of radio resources for use by the second wireless communication device 7 to transmit data to the first wireless communication device 2. When the second wireless communication device 7 switches to the survival time mode (duration), the control unit 3 reinforces data transmission by increasing or changing the allocation of radio resources in terms of the frequency band and the time domain (S1). For example, the control unit 3 allocates, as radio resources for use by the second wireless communication device 7 to transmit data, radio resources in a different frequency band or a different time domain from those of radio resources used in a normal state (durations other than the survival time mode (duration)). For example, the control unit 3 performs control to increase the transmission power or to increase the likelihood of data reaching the wireless communication device 2.

The control unit 3 also controls configuration of a radio measurement duration in the second wireless communication device 7 (S2). The second wireless communication device 7 performs radio measurement at a predetermined timing. A duration (period of time) during which the radio measurement is performed is referred to as “radio measurement duration”. The radio measurement is, for example, processing in which the second wireless communication device 7 searches for a communication device (or a frequency band) other than the first wireless communication device 2 (or a serving frequency band) with (or in) which the second wireless communication device 7 is communicating. There are cases where the second wireless communication device 7 is not able to transmit and receive data to and from the first wireless communication device 2 in a radio measurement duration. The control unit 3 performs control such that, for example, the second wireless communication device 7 does not perform radio measurement during the survival time mode (duration). Note that the control unit 3 controls the configuration of the radio measurement duration in accordance with information 5 on the radio measurement duration and survival time 6 (for example, time taken until data arrives).

The second wireless communication device 7 is a communication device including a second control unit 8 and a second communication unit 9. The second control unit 8 and the second communication unit 9 are composed, for example, of a processor (computer) included in the second wireless communication device 7 executing a program loaded into a memory.

The second control unit 8 controls wireless communication in accordance with the control of the first wireless communication device 2. Also, for example, when the second control unit 8 recognizes that data has failed to arrive N times (N is an integer of 1 or greater), the second control unit 8 switches to the survival time mode (duration).

The communication unit 4 and the second communication unit 9 communicate wirelessly with each other. The communication unit 4 performs wireless communication in accordance with the control unit 3. The second communication unit 9 performs wireless communication in accordance with the second control unit 8.

When the second wireless communication device 7 is in the survival time mode (duration), the first wireless communication device 2 can improve the probability of data arrival by controlling the allocation of radio resources for enhancing data transmission in terms of the frequency band and the time domain. Furthermore, the first wireless communication device 2 can perform control in order to avoid interference with data transmission during the survival time mode (duration), by controlling the configuration of the radio measurement duration in accordance with the information on the radio measurement duration as well as the survival time.

### Second Embodiment

A second embodiment will be described.

### Wireless Communication System 10

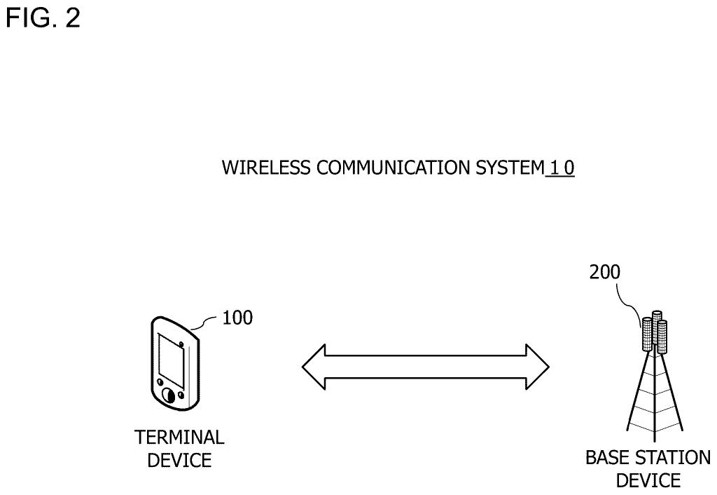

FIG. 2 illustrates an example configuration of a wireless communication system 10. The wireless communication system 10 includes a base station device 200 and a terminal device 100. The wireless communication system 10 is, for example, a wireless communication system installed in a system. An example is a wireless communication system with IIOT capability.

The terminal device 100 is a communication device attached to a piece of equipment (apparatus) in the system. The base station device 200 is a communication device installed in the system.

The base station device 200 supports, for example, various communication generations (for example, 5G, Beyond 5G, and the like). The base station device 200 may be composed of a single unit or multiple units such as a CU (Central Unit) and a DU (Distributed Unit).

In the wireless communication system 10, the base station device 200 and the terminal device 100 communicate with each other using the IIOT. In addition, it is assumed that the terminal device 100 and the base station device 200 support survival time.

### Example Configuration of Base Station Device 200

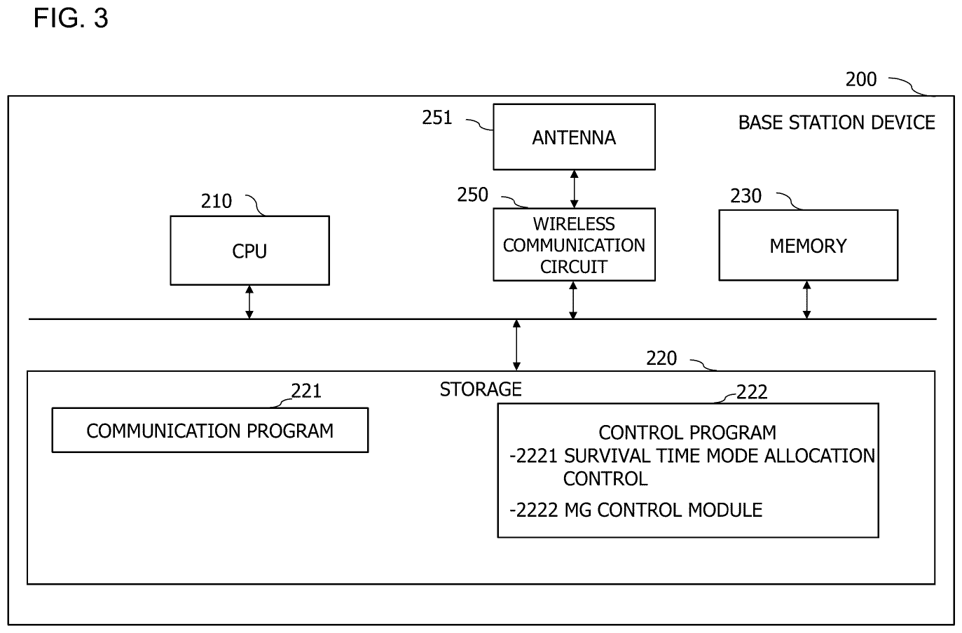

FIG. 3 illustrates an example configuration of the base station device 200. The base station device 200 includes a CPU (Central Processing Unit) 210, a storage 220, a memory 230, a wireless communication circuit 250, and an antenna 251.

The storage 220 is an auxiliary storage device, such as flash memory, an HDD (Hard Disk Drive), or an SSD (Solid State Drive), that stores programs and data. The storage 220 stores a communication program 221 and a control program 222.

The memory 230 is an area into which a program stored in the storage 220 is loaded. The memory 230 may also be used as an area in which a program stores data.

The wireless communication circuit 250 is a device that performs wireless communication with the terminal device 100. The wireless communication circuit 250 has the antenna 251. The antenna 251 includes, for example, a directional antenna capable of controlling the direction of transmission and reception of radio waves.

The CPU 210 is a processor that loads programs stored in the storage 220 into the memory 230, executes the loaded programs, composes various units, and realizes various types of processing.

The CPU 210 composes a communication unit and performs communication processing, by executing the communication program 221. The communication processing is processing for performing wireless communication with the terminal device 100. In the communication processing, the base station device 200 connects wirelessly to the terminal device 100, transmits data and control signals to the terminal device 100, and receives data from the terminal device 100.

The CPU 210 composes a control unit and performs control processing, by executing the control program 222. The control processing is processing for controlling wireless communication with the terminal device 100. In the control processing, the base station device 200 controls the allocation of radio resources for use by the terminal device 100 in the survival time mode (duration) (for example, the base station device 200 allocates resources for enhancing data transmission, instructs cancellation of radio resources used in a normal state, increases the transmission power, performs control to increase the likelihood of data arrival, and so on). In the control processing, the base station device 200 also performs control of execution of a duration (for example, Measurement Gap, hereinafter also referred to as “MG”) during which radio measurement is performed by the terminal device 100 (for example, the base station device 200 instructs whether or not to perform the measurement and when to perform the measurement).

The CPU 210 composes the control unit and performs survival time mode allocation control processing, by executing a survival time mode allocation control module 2221 of the control program 222. The survival time mode allocation control processing is processing for controlling allocation of radio resources for use by the terminal device 100 during the survival time mode. In the survival time mode allocation control processing, the base station device 200, for example, adds radio resources (in order to reinforce data transmission) in terms of at least one of the frequency band and the time domain. For example, the base station device 200 performs control to increase the transmission power or to increase the likelihood of data reaching the base station device 200.

The CPU 210 composes the control unit and performs MG control processing, by executing an MG control module 2222 of the control program 222. The MG control processing is processing for controlling, for example, whether or not to perform Measurement Gap in the terminal device 100. In the MG control processing, the base station device 200 performs control such that, for example, Measurement Gap is not performed during the survival time mode.

### Example Configuration of Terminal Device 100

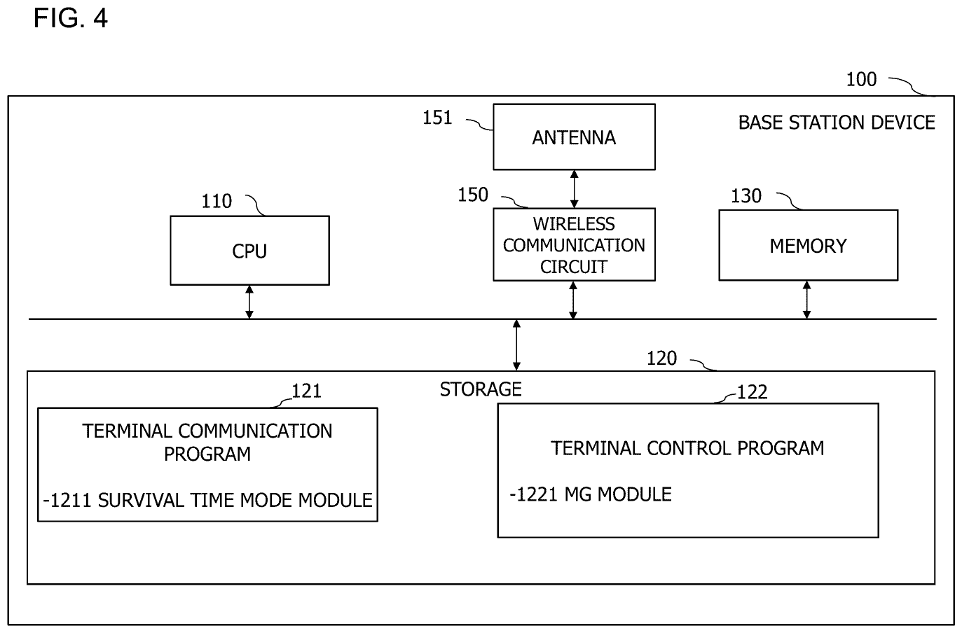

FIG. 4 illustrates an example configuration of the terminal device 100. The terminal device 100 includes a CPU 110, a storage 120, a memory 130, a wireless communication circuit 150, and an antenna 151.

The storage 120 is an auxiliary storage device, such as flash memory, an HDD, or an SSD, that stores programs and data. The storage 120 stores a terminal communication program 121 and a terminal control program 122.

The memory 130 is an area into which a program stored in the storage 120 is loaded. The memory 130 may also be used as an area in which a program stores data.

The wireless communication circuit 150 is a device that performs wireless communication with the base station device 200. The wireless communication circuit 150 has the antenna 151. The antenna 151 includes, for example, a directional antenna capable of controlling the direction of transmission and reception of radio waves.

The CPU 110 is a processor that loads programs stored in the storage 120 into the memory 130, executes the loaded programs, composes various units, and realizes various types of processing.

The CPU 110 composes a second communication unit and performs terminal communication processing, by executing the terminal communication program 121. The terminal communication processing is processing for performing wireless communication with the base station device 200.

The CPU 110 composes the second communication unit and a second control unit and performs survival time mode processing, by executing a survival time mode module 1211 included in the terminal communication program 121. The survival time mode processing is processing for performing communication in the survival time mode. In the survival time mode, the terminal device 100 uses radio resources (including radio resources for enhancing data transmission) allocated by the base station device 200, and transmits data under the control (such as an increase in data transmission power) that increases the likelihood of given data reaching the base station device 200.

The CPU 110 composes the second control unit and performs terminal control processing, by executing the terminal control program 122. The terminal control processing is, for example, processing in which communication is controlled by the base station device 200.

The CPU 110 composes the second control unit and performs MG processing, by executing an MG module 1221 included in the terminal control program 122. The MG processing is processing for performing (or not performing) MG in accordance with an instruction from the base station device 200. For example, in the MG processing, the terminal device 100 does not perform MG (or postpones MG or leaves MG in pending) during the survival time mode, in accordance with an instruction from the base station device 200.

### Survival Time Mode

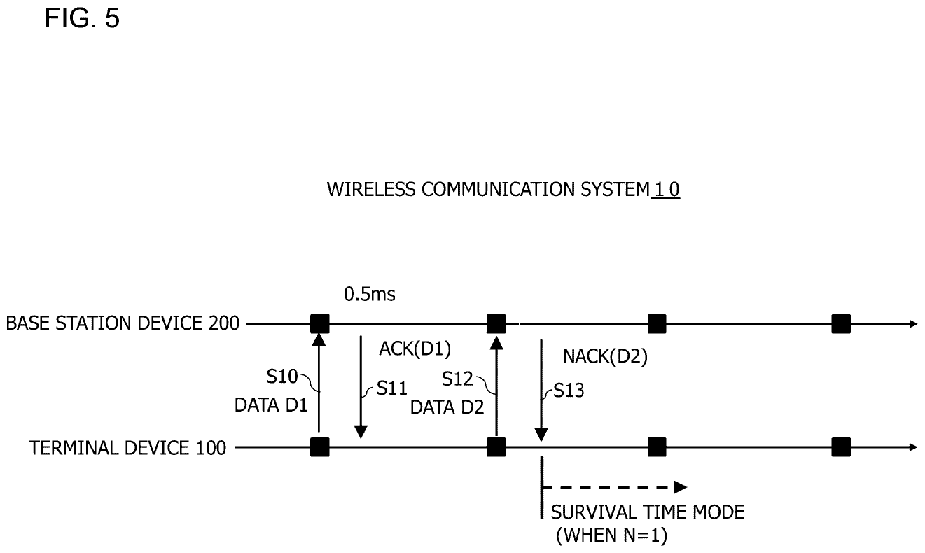

FIG. 5 illustrates an example of the survival mode. The terminal device 100 of the wireless communication system 10 in FIG. 5 transmits data to the base station device 200. For example, the terminal device 100 transmits data (or acquires a trigger for data transmission) at intervals of 0.5 ms. In FIG. 5, the transmission interval is indicated by black squares.

When the terminal device 100 recognizes that data transmission has failed N times (N is an integer of 1 or greater), the terminal device 100 transitions to the survival time mode. In FIG. 5, it is assumed that N is 1, and the terminal device 100 recognizes that data transmission has failed N times upon receiving NACK (Non Acknowledgement: negative acknowledge). Although the term “NACK” is used here for convenience, the NACK is more specifically a control signal in the physical layer (L1). In the case of 5G, the NACK corresponds to an UL grant that prompts retransmission. However, the NACK is not limited to this. The NACK may be any control signal for transition to the survival mode.

The terminal device 100 transmits data D1 to the base station device 200 (S10). The base station device 200 successfully receives the data D1, and transmits ACK (Acknowledgement: positive acknowledge) indicating that the data D1 has been successfully received to the terminal device 100 (S11). Depending on the wireless communication system, there are cases where ACK is not be returned. In such cases, the terminal device 100 recognizes that the data transmission was successful, for example, by not receiving NACK for a predetermined period of time.

The terminal device 100 transmits data D2 to the base station device 200 (S12). The base station device 200 fails to receive the data D2, and transmits NACK indicating that the data D2 has not been successfully received to the terminal device 100 (S13). The terminal device 100 receives the NACK, and transitions to the survival time mode because the terminal device 100 has received NACK a predetermined number of times.

The survival time mode ends, for example, when a predetermined period of time has elapsed. Alternatively, the survival time mode may end depending on the number of data transmissions or the number of successful data transmissions. Furthermore, the survival time mode may end when the radio conditions become better than a predetermined level.

In the survival time mode, in order to reinforce data transmission, the terminal device 100 adds radio resources to be used. Hereinafter, the radio resources added in order to reinforce data transmission in the survival mode may also be referred to as “additional radio resources”. Patterns of reinforcement will be described below.

### Reinforcement in Frequency Domain

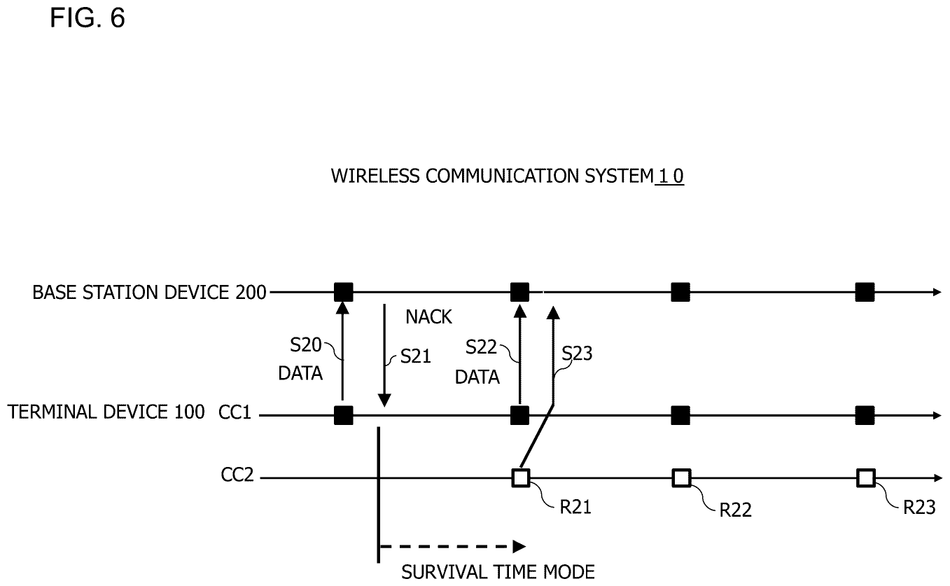

FIG. 6 illustrates an example in which radio resources are added in order to reinforce data transmission in the frequency domain. In FIG. 6, it is assumed that the frequency bands of CC1 and CC2 are different. Note that radio resources of CC2 are, for example, radio resources that have been agreed on (or allocated by RRC control signals) in advance between the terminal device 100 and the base station device 200.

The terminal device 100 transmits data to the base station device 200 using a radio resource of CC1 (S20). If the base station device 200 fails to receive the data, the base station device 200 transmits NACK indicating that the data has not been successfully received to the terminal device 100 (S21). The terminal device 100 receives the NACK, and transitions to the survival time mode because the terminal device 100 has received NACK a predetermined number of times.

The terminal device 100 uses, as additional radio resources, radio resources R21, R22, and R23 that are radio resources of CC2 and are on the same time axes as radio resources with which data has been transmitted (or/and will be transmitted).

The terminal device 100 uses a radio resource that is also used by the terminal device 100 when not in the survival time mode and the additional radio resource R21 to retransmit the data or transmit new data (S22, S23). The data transmitted here may be, for example, the data for which NACK was received and which is to be retransmitted, or other data. Furthermore, the same or different data may be transmitted on the radio resources of CC1 and CC2.

### Reinforcement in Time Domain: Pattern 1

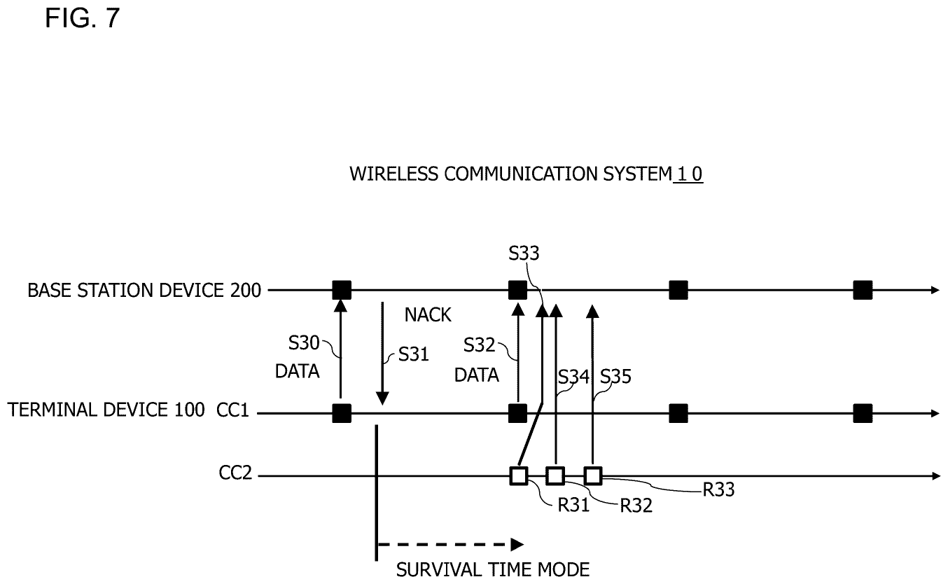

FIG. 7 illustrates an example (pattern 1) in which radio resources are added in order to reinforce data transmission in the time domain.

The terminal device 100 transmits data to the base station device 200 using a radio resource of CC1 (S30). If the base station device 200 fails to receive the data, the base station device 200 transmits NACK indicating that the data has not been successfully received to the terminal device 100 (S31). The terminal device 100 receives the NACK, and transitions to the survival time mode because the terminal device 100 has received NACK a predetermined number of times.

The terminal device 100 uses, as additional radio resources, radio resources R31, R32, and R33 that are radio resources of CC2, the radio resource R31 being on the same time axis as, and the radio resources R32 and R33 each being on a different time axis from, a radio resource with which data has been transmitted (or/and will be transmitted).

The terminal device 100 uses a radio resource that is also used by the terminal device 100 when not in the survival time mode and the additional radio resources R31, R32, and R33 to retransmit the data or transmit new data (S32, S33, S34, S35).

An example of the measures for adding radio resources in order to reinforce data transmission in the time domain is to apply repetition Type A/Type B to PUSCH. Repetition Type A is a technique for repeatedly transmitting data in units of slots, and repetition Type B is a technique for repeatedly transmitting data in a single slot.

Another example of the measures for adding radio resources in order to reinforce data transmission in the time domain is to preconfigure TBOMS. With use of the TBOMS function, for example, a single TB corresponding to data to be transmitted can be transmitted over multiple slots.

Note that, in FIG. 7, the terminal device 100 allocates the additional radio resources R32 and R33 on CC2, which is of a different frequency band, but the additional radio resources R32 and R33 may be allocated on CC1, which is of the same frequency band. However, since it is supposed that the base station device 200 controls a plurality of terminal devices 100, for example, CC1 may also be used by other terminal devices 100. In this case, the base station device 200 performs control so that the terminal device 100 can occupy the additional radio resources R32 and R33 of CC1, for example, by restricting or canceling the use of CC1 by the other terminal devices 100.

Although there are three additional radio resources R31, R32, and R33 in FIG. 7, the number of additional radio resources may be less than or more than three. The number of additional radio resources is instructed by the base station device 200, for example. For example, the base station device 200 specifies the maximum number of times in advance using an RRC message, broadcast information, or the like. The terminal device 100 allocates additional radio resources within the specified maximum number of times. Alternatively, the base station device 200 may instruct the terminal device 100 of the number of additional radio resources, at the timing of transitioning to the survival time mode (for each survival time mode) by, for example, including the number of additional radio resources for this time in NACK or the like, within the maximum number of times specified in advance.

### Reinforcement in Time Domain: Pattern 2

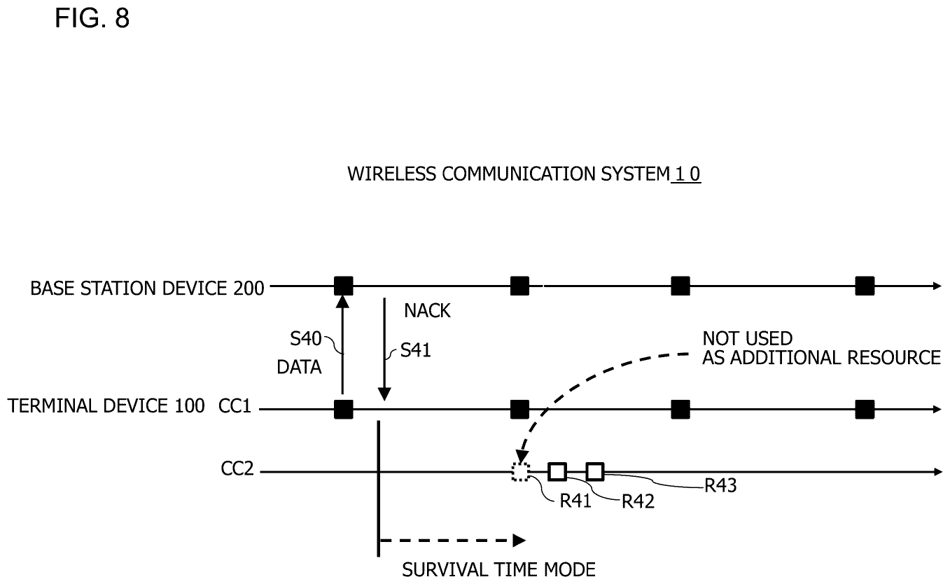

FIG. 8 illustrates an example (pattern 2) in which radio resources are added in order to reinforce data transmission in the time domain. Data transmission using the additional radio resources is not illustrated in FIG. 8. When the terminal device 100 has extra transmission power, the transmission timing for the normal radio resource and the transmission timing for the additional radio resource R31 may be the same, as in the pattern 1. However, when the terminal device 100 does not have extra transmission power, if the transmission timing for the normal radio resource and the transmission timing for the additional radio resource R31 are the same as in the pattern 1, the transmission output power for at least one of the radio resources is low, and thus, there are cases where transmitted data does not arrive at the base station device 200 with sufficient power. To address this issue, in the pattern 2, the terminal device 100 ensures that a normal radio resource and an additional radio resource do not overlap in the time domain.

The terminal device 100 transmits data to the base station device 200 using a radio resource of CC1 (S40). If the base station device 200 fails to receive the data, the base station device 200 transmits NACK indicating that the data has not been successfully received to the terminal device 100 (S41). The terminal device 100 receives the NACK, and transitions to the survival time mode because the terminal device 100 has received NACK a predetermined number of times.

The terminal device 100 does not use, as an additional radio resource, a radio resource R41 that is a radio resource of CC2 and is on the same time axis as a radio resource with which data has been transmitted (or/and will be transmitted).

The terminal device 100 uses, as additional radio resources, radio resources R42 and R43 that are each on a different time axis from a radio resource with which data has been transmitted (or/and will be transmitted).

In this manner, the terminal device 100 allocates, as additional radio resources, radio resources that do not overlap in the time domain.

### Reinforcement in Time Domain: Pattern 3

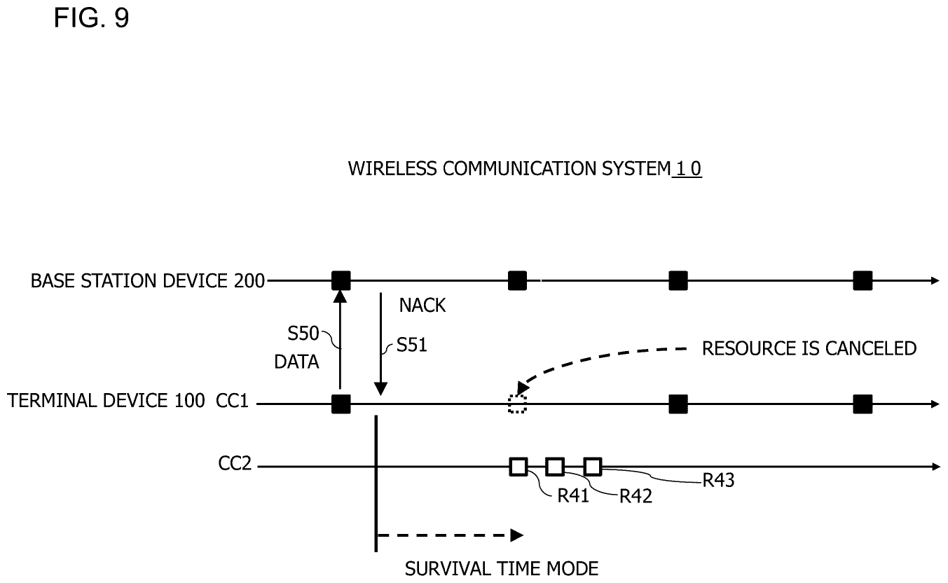

FIG. 9 illustrates an example (pattern 3) in which radio resources are added in order to reinforce data transmission in the time domain. Data transmission using additional radio resources is not illustrated in FIG. 9. In the pattern 2, the terminal device 100 does not allocate an additional radio resource that overlaps a normal radio resource in the time domain; however, in the pattern 3, the terminal device 100 allocates an additional radio resource that overlaps a normal radio resource in the time domain, and cancels the normal radio resource.

The terminal device 100 transmits data to the base station device 200 using a radio resource of CC1 (S50). If the base station device 200 fails to receive the data, the base station device 200 transmits NACK indicating that the data has not been successfully received to the terminal device 100 (S51). The terminal device 100 receives the NACK, and transitions to the survival time mode because the terminal device 100 has received NACK a predetermined number of times.

The terminal device 100 uses, as additional radio resources, radio resources R51, R52, and R53 that are radio resources of CC2, the radio resource R51 being on the same time axis as, and the radio resources R52 and R53 each being on a different time axis from, a radio resource with which data has been transmitted (or/and will be transmitted).

On the other hand, the terminal device 100 cancels (does not use) a normal radio resource. The normal radio resource is a radio resource of CC1 and is of a frequency band in which the NACK has previously been received, and therefore, use of CC2 may lead to a higher probability of data arrival.

### Relation to Measurement Gap

Measurement Gap refers to the measurement of the quality of reception from a currently communicating cell (base station device) as well as the radio signal reception quality in a band different from the current band, although the serving frequency is the same, and the radio signal reception quality in other frequency bands or from different RATs, or the measurement period or control. When a wireless communication circuit (RF system) used for MG and a wireless communication circuit (RF system) used for communication are the same, the terminal device 100, during MG, is not able to transmit and receive data to and from the base station device 200 with which the terminal device 100 is currently communicating. Therefore, the wireless communication system 10 needs to perform MG control including whether or not to perform MG during the survival time mode.

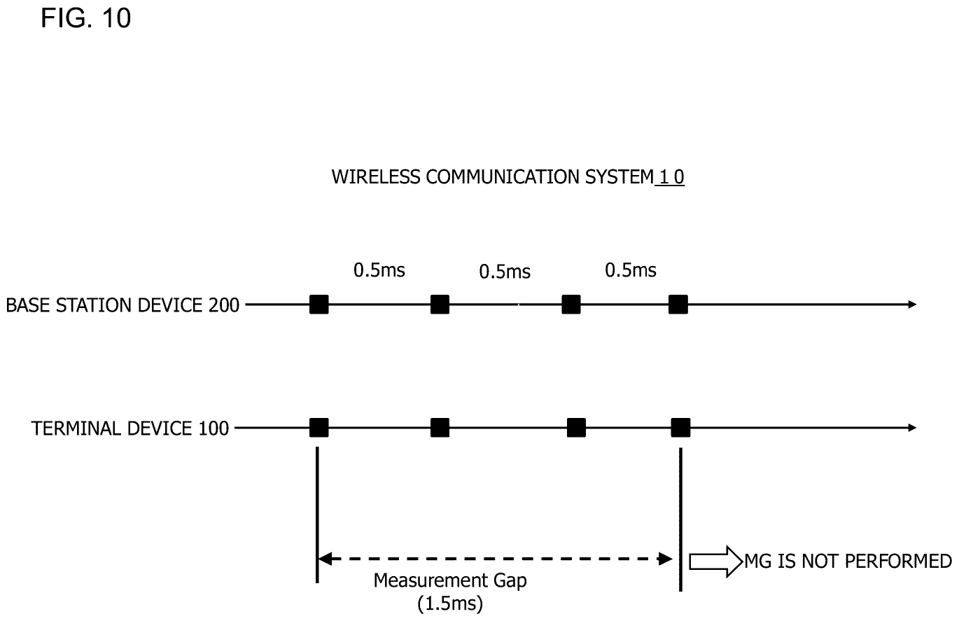

FIG. 10 illustrates an example of whether or not MG is performed when the MG duration is longer than the transmission interval. In FIG. 10, the MG duration is 1.5 ms, and the transmission periodicity is 0.5 ms. Note that the transmission periodicity is assumed to be the same value as the survival time.

As illustrated in FIG. 10, if the terminal device 100 performs MG during the survival time mode, the terminal device 100 is not able to transmit data to the base station device 200 for 1.5 ms, which is the MG duration. For this reason, when the MG duration is longer than the survival time (transmission periodicity), the terminal device 100 does not perform MG.

Note that, in the case where MG is not performed, for example, a RF system for Inter-BWP/Inter-F/Inter-RAT is provided separately.

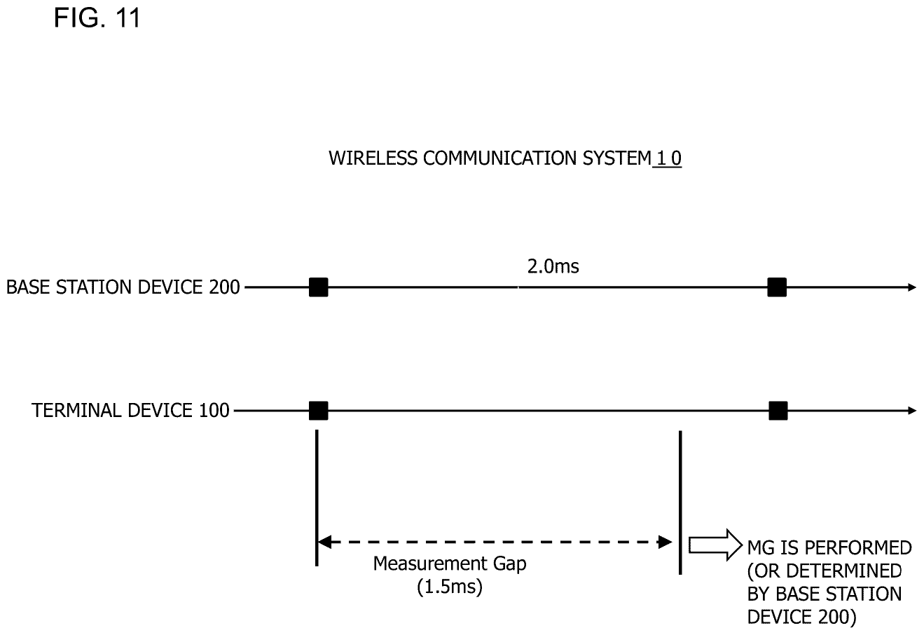

FIG. 11 illustrates an example of whether or not MG is performed when the MG duration is shorter than the transmission interval. In FIG. 10, the MG duration is 1.5 ms, and the transmission periodicity is 2.0 ms.

As illustrated in FIG. 11, even when the terminal device 100 performs MG during the survival time mode, the terminal device 100 can transmit data to the base station device 200 while MG is not performed, although the terminal device 100 is not able to transmit data for 1.5 ms, which is the MG duration. For this reason, when the MG duration is shorter than the survival time (transmission periodicity), the terminal device 100 performs MG. Alternatively, when the MG duration is shorter than the survival time, whether or not to perform MG may be determined according to an instruction from the base station device 200 or may be optional, for example.

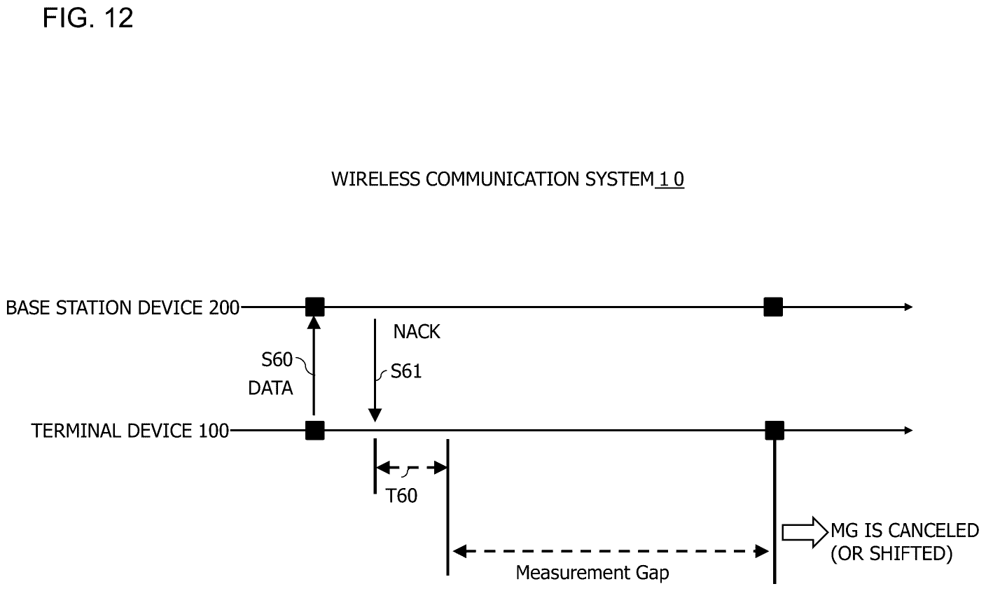

FIG. 12 illustrates an example in which MG is performed when the MG duration is shorter than the transmission interval. In FIG. 12, the MG duration is 1.5 ms, and the transmission periodicity is 2.0 ms.

The terminal device 100 transmits data to the base station device 200 (S60). If the base station device 200 fails to receive the data, the base station device 200 transmits NACK indicating that the data has not been successfully received to the terminal device 100 (S61). The terminal device 100 receives the NACK, and transitions to the survival time mode because the terminal device 100 has received NACK a predetermined number of times.

As illustrated in FIG. 12, when the difference between the survival time and the MG duration is small, a period T60 during which data can be transmitted after the terminal device 100 receives NACK is at most 0.5 ms (transmission interval-MG duration), and thus, there are cases where data transmission is not possible or a sufficient number of retransmissions is not possible. Therefore, MG may be canceled or shifted if the time T60 is shorter than a predetermined length of time (first length of time) (or without any time conditions). In the case of shifting, the timing at which MG is performed later may be, for example, a timing instructed by the base station device 200, a timing at which the survival time mode ends, or the like.

Also, in the case of a wireless communication system that transmits ACK, the terminal device 100 may terminate the survival time mode at the timing of reception of ACK and execute the shifted (canceled) MG.

Furthermore, a terminal device 100 supporting survival time may be preconfigured so that MG is unimplemented or the terminal device 100 is not allowed to perform MG. Such a terminal device may notify the base station device 200 that the terminal device supports survival time by using RRC control signals.

### OTHER EMBODIMENTS

The requirements described in the first, second, and other embodiments may be combined. Also, the requirements described in the first, second, and other embodiments may be used differently depending on, for example, the radio conditions, system requirements, or the like.

For example, when defined as 3GPP standardized specifications, the requirements described in the first, second, and other embodiments will be as follows.
In 3GPP TS38.331 (RRC), a statement to the effect that repetition in time domain shall be set only in CG (configured grant-based) resource to be boosted (added in order to reinforce data transmission) will be added.
In 3GPP TS38.306 (UE capability), a statement to the effect that MG is not configured for UE (terminal device) supporting a survival time of 0.5 ms/1 ms (or in other words, the UE is not configured to not perform MG) will be added. The reason why the survival time is specified to be “0.5 ms/1 ms” is that cases where the survival time is shorter than “1.5 ms”, which is the minimum length of time of MG, are assumed. In practice, the UE for which MG is not configured may be any UE that supports only a survival time shorter than the MG duration. In 3GPP TS38.306 (UE capability), for example, the following phrase will be stated for the relevant UE: “shall not support measurement gap” or “is not required to support measurement gap”.

On the other hand, in 3GPP TS38.306 (UE capability), a statement to the effect that MG can be supported in the case of UE supporting a survival time of 2.0 ms (in the case where the survival time is longer than the MG duration) will be added. In 3GPP TS38.306 (UE capability), for example, the following phrase will be stated for the UE supporting a survival time of 2.0 ms: “can support measurement gap”.

Furthermore, in 3GPP TS38.306 (UE capability), a statement to the effect that MG is not configured for UE supporting survival time may also be added. In this case, in 3GPP TS38.306 (UE capability), the following phrase may be stated for the UE supporting survival time: “shall not support measurement gap” or “is not required to support measurement gap”.
In 3GPP TS38.321 (MAC specification), a statement to the effect that, in survival time mode, transmission of PUSCH is allowed even during MG will be added. In 3GPP TS38.321 (MAC specification), for example, the following phrase will be stated: “MAC entity shall transmit PUSCH regardless of the possible occurrence of a measurement gap”.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

1. A first wireless communication device included in a wireless communication system, the first wireless communication device comprising:
a communicator configured to perform communication with a second wireless communication device supporting a survival time; and
a controller configured to:
control allocation of a radio resource for data transmission in terms of frequency band and time domain, in a survival time mode in which the survival time is being applied, and
control, in accordance with the survival time and information on a radio measurement duration during which the second wireless communication device performs radio measurement, configuration of the radio measurement duration.

2. The first wireless communication device according to claim 1,
wherein the radio measurement duration is a duration during which communication with the second wireless communication device does not need to be performed.

3. The first wireless communication device according to claim 2,
wherein, when the radio measurement duration is equal to or shorter than the survival time, the controller performs control such that the second wireless communication device does not perform the radio measurement.

4. The first wireless communication device according to claim 3,
wherein, when the radio measurement duration is longer than the survival time, the controller performs control such that the second wireless communication device performs the radio measurement.

5. The first wireless communication device according to claim 3,
wherein, when the radio measurement duration is longer than the survival time, and a difference between the radio measurement duration and the survival time is a first length of time or shorter, the controller performs control such that the second wireless communication device does not perform the radio measurement.

6. The first wireless communication device according to claim 1,
wherein, when reception of data from the second wireless communication device has failed, the controller transmits a signal to the second wireless communication device, the signal enabling the second wireless communication device to recognize that the data reception has failed, and cause the second wireless communication device to transition to a survival time duration.

7. The first wireless communication device according to claim 1,
wherein the controller does not allocate, as a radio resource to be added in order to reinforce data transmission in a survival time duration, a radio resource that overlaps, in the time domain, a radio resource used in a duration other than the survival time duration.

8. The first wireless communication device according to claim 1,
wherein the controller determines, depending on transmission power, whether or not to allocate, as the radio resource in the survival time mode, a radio resource that overlaps, in the time domain, a radio resource used in a duration other than the survival time mode.

9. The first wireless communication device according to claim 1,
wherein, in a survival time duration, the controller does not use, for data transmission, a radio resource used in a duration other than the survival time duration.

10. The first wireless communication device according to claim 1,
wherein the radio measurement duration is a Measurement Gap.

11. The first wireless communication device according to claim 1,
wherein the survival time is a data transmission interval of the second wireless communication device.

12. A second wireless communication device included in a wireless communication system and supporting a survival time, the second wireless communication device comprising:
a second communicator configured to perform communication with a first wireless communication device; and
a second controller to which a radio resource for data transmission in terms of frequency band and time domain, in a survival time mode in which the survival time is being applied, is allocated by the first wireless communication device, and for which, in accordance with the survival time and information on a radio measurement duration during which radio measurement is performed, configuration of the radio measurement duration is controlled by the first wireless communication device.

13. A wireless communication system comprising a first wireless communication device and a second wireless communication device supporting a survival time,
the first wireless communication device including:
a communicator configured to perform communication with the second wireless communication device; and
a controller configured to control allocation of a radio resource for data transmission in terms of frequency band and time domain, in a survival time mode in which the survival time is being applied, and configured to control, in accordance with the survival time and information on a radio measurement duration during which the second wireless communication device performs radio measurement, configuration of the radio measurement durations, and
the second wireless communication device including:
a second communicator configured to perform communication with the first wireless communication device; and
a second controller configured to, in the survival time mode, uses the radio resource allocated by the first wireless communication device for the communication and performs the radio measurement as controlled by the first wireless communication device.
